(19) United States
(12) Patent Application Publication
(10) Pub. No.: US 2003/0086344 A1
(43) Pub. Date: May 8, 2003

(54) Apparatus and method for slicing a pre-pit signal

(76) Inventor: Abraham Kuo, Hsin Chu (TW)

Correspondence Address: BIRCH STEWART KOLASCH & BIRCH, PO BOX 747, FALLS CHURCH, VA, 22040-0747, US

(21) Appl. No.: 10/284,380

(22) Filed: Oct. 31, 2002

(30) Foreign Application Priority Data
Nov. 2, 2001 (TW) 090127379

(51) Int. Cl. G11B 7/005

(52) U.S. Cl. 369/47.35; 369/59.17

(57) ABSTRACT

A slicing apparatus for slicing a pre-pit signal is disclosed. The slicing apparatus utilizes a reference signal with a dynamical voltage to slice a pre-pit signal. The slicing apparatus includes a peak detector, a low-pass filter, a calculating unit, and a comparator. The peak detector detects the peak value of the pre-pit signal to generate a peak signal. The low-pass filter filters out the high-frequency components of the pre-pit signal to generate a DC signal. The calculating unit sums up the peak signal and the DC signal, and then divides the sum value by a predetermined value, so as to generate the reference signal. The comparator compares the pre-pit signal with the reference signal to generate an output signal. Accordingly, even though the amplitude of the pre-pit signal is not always the same, the voltage of the reference signal may also be dynamically adjusted to make the comparator generate a correct output signal.

### BACKGROUND OF THE INVENTION

1. Field of the Invention

The invention relates generally to an apparatus and a method for slicing a pre-pit signal, and more specifically to an apparatus and a method for slicing a pre-pit signal using a reference signal with a dynamical voltage.

2. Description of the Related Art

In a typical Digital Versatile Disk-Recordable (hereinafter referred to as DVD-R) system, the pre-pits are additionally formed at positions between adjacent tracks to record address information so that the frequency of the wobbling tracks can be correctly detected. Since the pre-pits are uniformly formed on the whole surface of the DVD-R, the reference addresses of the DVD-R may be reproduced from reading the information of the pre-pits.

FIG. 1 is a block diagram showing a system for slicing a pre-pit signal read from a typical DVD-R driver. Referring to FIG. 1, the slicing apparatus 19 utilizes a low-pass filter 35 to filter out the high-frequency components of the input signal (RF signal) Spp, and then to generate a DC signal Sl2. Next, the slicing apparatus 19 utilizes an adder 36 to add a voltage 45 to the DC signal Sl2, and then to generate a reference signal Sla2. Finally, the slicing apparatus 19 utilizes a comparator 37 to compare the voltage of the input signal Spp with the voltage of the reference signal Sla2, and then to generate a sliced signal Sc2. FIG. 2 shows the waveform of an RF signal. As shown in FIG. 2, the signal with a smaller amplitude denotes the recorded information, while the line surges with larger amplitudes denote the pre-pit signal. The slicing apparatus shown, in FIG. 1 is used to slice the line surges with larger amplitudes.

In general, the amplitude of the pre-pit signal is influenced by several factors including the quality of the DVD-R, the reflection factor of light on the recording surface, the distance variation between pick-up head and disc when disc is rotating, the laser power variation of the amplitude of the pre-pit signal if the voltage of the reference signal is generated by adding a constant voltage to a DC level, as shown in FIG. 1.

### SUMMARY OF THE INVENTION

In view of the above-mentioned problems, an object of the invention is to provide a slicing apparatus and method in which the voltage of a reference signal is dynamically adjusted.

To achieve the above-mentioned object, the slicing apparatus for slicing a pre-pit signal of the invention includes a peak detector, a low-pass filter, a calculating unit, and a comparator. The peak detector detects the peak value of the pre-pit signal and provides a peak signal with peak value. The low-pass filter filters out the high-frequency components of the pre-pit signal and generates a DC signal. The calculating unit sums up the peak signal and the DC signal, and then divides the sum value by a predetermined value, so as to generate the reference signal. The comparator compares the pre-pit signal with the reference signal to generate an output signal.

Accordingly, even though the amplitude of the pre-pit signal changes, the voltage of the reference signal may also be dynamically adjusted to make the comparator generate a correct output signal.

### BRIEF DESCRIPTION OF THE DRAWINGS

FIG. 1 is a block diagram showing a conventional slicing apparatus for slicing a pre-pit signal.

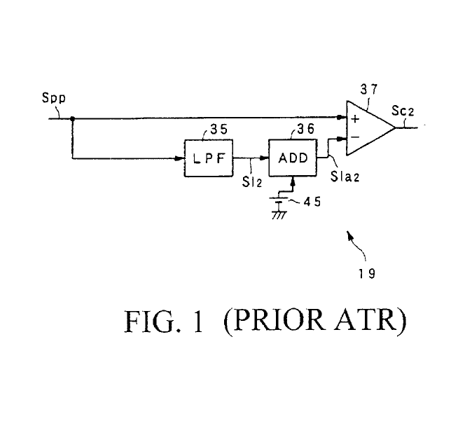

FIG. 2 shows the waveform of a typical pre-pit signal.

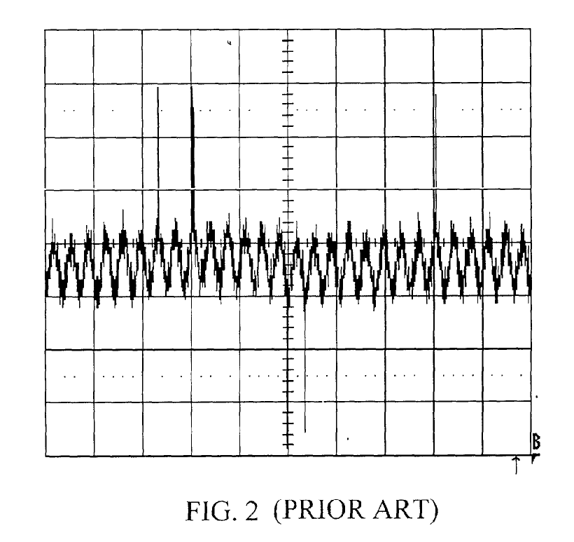

FIG. 3 is a block diagram showing a slicing apparatus for slicing a pre-pit signal of the present invention.

### DETAILED DESCRIPTION OF THE INVENTION

The slicing apparatus and method for slicing a pre-pit signal of the invention will be described with reference to the accompanying drawing.

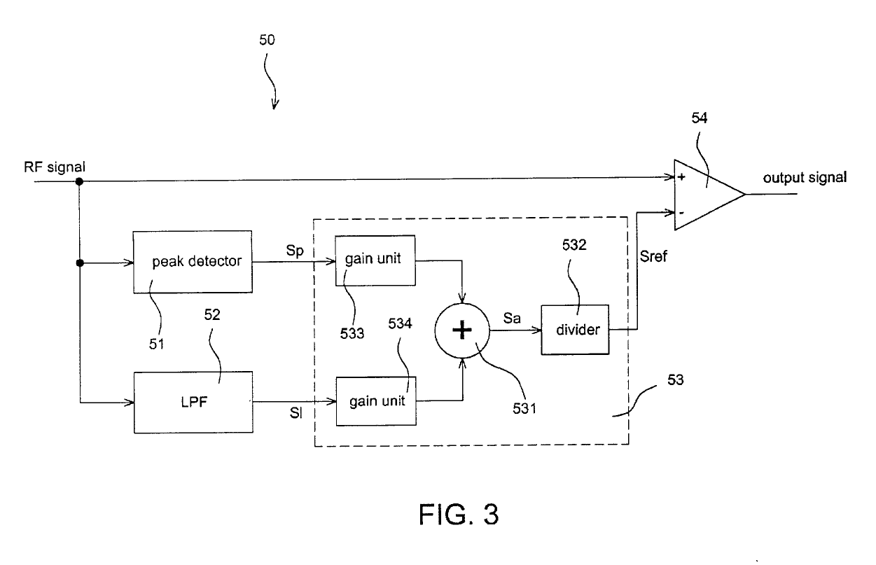

FIG. 3 is a block diagram showing a slicing apparatus for slicing a pre-pit signal of the invention. Referring to FIG. 3, the slicing apparatus 50 for slicing a pre-pit signal of the invention includes a peak detector 51, a low-pass filter 52, a calculating unit 53, and a comparator 54. The peak detector 51 detects the peak value of the input signal RF and generates a peak signal Sp. The low-pass filter 52 filters out the high-frequency components of the input signal RF and generates a DC signal S1. The calculating unit 53 adds the peak signal Sp to the DC signal S1 to obtain a sum value, and then divides the sum value by a predetermined value to generate a reference signal Sref. The comparator 54 compares the input signal RF with the reference signal Sref to generate a output signal.

The peak detector 51 receives the input signal RF, and outputs the peak signal Sp with peak value of the input signal RF. The peak detector 51 may be implemented using a diode and an RC circuit. Of course, the peak detector 51 may also be implemented using other circuits having the same function as that mentioned above. In addition, the low-pass filter 52 is used to acquire the DC component of the input signal RF, which is also the average amplitude of the input signal RF.

The calculating unit 53 calculates the voltage of the reference signal Sref based on the peak signal Sp and the DC signal S1. In this embodiment, the calculating unit 53 includes an adder 531, a voltage regulator 532, and two gain units 533, 534. The gain unit 533 receives the peak signal Sp and adjusts the amplitude of the peak signal Sp, while the gain unit 534 receives the DC signal S1 and adjusts the amplitude of the DC signal S1. The adder 531 adds the adjusted peak signal to the adjusted DC signal. The voltage regulator 532 regulates the output value from the adder 531 to be one half and then outputs the one-half value. In this embodiment, although the voltage regulator 532 divides the output value from the adder 531 by 2, the voltage regulator 532 may also divide the output value by any other suitable values. Of course, the voltage regulator 532 may also subtract a predetermined voltage value from the output value of the adder 531. It is noted that the gain units 533, 534 can be omitted.

Because the slicing apparatus for slicing a pre-pit signal of the invention utilizes the peak detector to detect the peak value of the input signal RF, and also utilizes the calculating unit to dynamically adjust the voltage of the reference signal of the comparator according to the peak value of the input signal RF, the comparator can correctly slice the pre-pit signal even though the peak value of the input signal RF varies.

The slicing method for slicing the pre-pit signal of the invention will be described in the following. The method includes the following steps:

Step 1: detect the peak value of the input signal RF and then generate a peak signal Sp.

Step 2: filter out the high-frequency components of the input signal RF and then generate a DC signal S1.

Step 3: calculate the voltage of the reference signal according to the peak signal Sp and the DC signal S1.

Step 4: compare the pre-pit signal with the reference signal and then generate an output signal.

In step 3, one embodiment of the invention generates the reference signal by summing up the peak signal Sp and the DC signal S1, and then dividing the sum value by 2. Of course, other methods may also be applied to this invention as long as the peak signal Sp and the DC signal S1 are used to generate the reference signal.

While a certain exemplary embodiment has been described and shown in the accompanying drawing, it is to be understood that such an embodiment is merely illustrative of and not restrictive on the broad invention, and that this invention not be limited to the specific construction and arrangement shown and described, since various other modifications may occur to those ordinarily skilled in the art.

What is claimed is:

1. A slicing apparatus for slicing a pre-pit signal read from discs, comprising:
a peak detector for detecting peak values of a pre-pit signal and generating a peak signal;
a low-pass filter for filtering out high-frequency components of the pre-pit signal and generating a DC signal;
a calculating unit for generating a reference signal with a dynamically adjusted voltage according to the peak signal and the DC signal; and
a comparator for comparing the pre-pit signal with the reference signal to generate an output signal;
whereby the slicing apparatus utilizes the reference signal with a dynamically adjusted voltage to slice the pre-pit signal and generate the output signal

2. The slicing apparatus according to claim 1, wherein the calculating unit comprises:
an adder for summing up the peak signal and the DC signal and outputting an summing signal; and
a divider for generating the reference signal by dividing the summing signal by 2.

3. A slicing method for slicing a pre-pit signal read from discs, comprising the steps of:
detecting a peak value of a pre-pit signal to generate a peak signal;
filtering out high-frequency components of the pre-pit signal to generate a DC signal;
generating a reference signal with a dynamically adjusted voltage according to the peak signal and the DC signal; and
comparing the pre-pit signal with the reference signal to generate an output signal,
whereby, the slicing method utilizes the reference signal with a dynamically adjusted voltage to slice the pre-pit signal and generate output signal.

4. The slicing method according to claim 3, wherein in the step of generating the reference signal is to sum up tile peak signal and the DC signal and then divided by 2.
